(19) United States
(12) Patent Application Publication
(10) Pub. No.: US 2026/0173111 A1
(43) Pub. Date: Jun. 18, 2026

(54) APPARATUS, METHOD AND COMPUTER PROGRAM

(71) Applicant: Nokia Technologies Oy, Espoo (FI)

(72) Inventors: Saurabh Khare, Bangalore (IN); Chaitanya Aggarwal, Munich (DE); Divya G Nair, Bangalore (IN); Shushu Liu, Espoo (FI)

(21) Appl. No.: 19/410,932

(22) Filed: Dec. 5, 2025

(30) Foreign Application Priority Data
Dec. 18, 2024 (IN) 202441100590

(51) Int. Cl. H04W 72/25; H04W 12/10; H04W 24/02

(52) U.S. Cl. CPC H04W 72/25; H04W 12/10; H04W 24/02

(57) ABSTRACT

There is provided as user equipment comprising: at least one processor and at least one memory storing instructions that, when executed by the at least one processor, cause the user equipment at least to perform receiving a request for data relating to the user equipment from a further user equipment, wherein the request comprises a reason for the request, generating tagging information, wherein the tagging information includes an indication of the data, an identifier of the user equipment and an identifier of the further user equipment and providing the generated tagging information to the further user equipment, wherein the generated tagging information is integrity protected.

### TECHNICAL FIELD

Various embodiments of this disclosure relate generally to methods, apparatus and computer programs, and in particular, but not exclusively, to enabling data usage and access tracking in 6G.

### BACKGROUND

A communication system can be seen as a facility that enables communication sessions between two or more communication devices, or provides communication devices access to a network. A mobile or wireless communication network is one example of a communication network. A communication device may be provided with a service by an application server.

A mobile or wireless communication network may operate in accordance with standard(s), such as those provided by 3GPP (Third Generation Partnership Project) or ETSI (European Telecommunications Standards Institute). Examples of mobile or wireless communication network that operate in accordance with 3GPP standards are generally referred to as 4G (4th Generation) networks, 5G (5th Generation) network, 5G-Advanced networks and 6G networks.

### SUMMARY

Some embodiments of this disclosure will be described with respect to certain aspects. These aspects are not intended to indicate key or essential features of the various example embodiments of this disclosure, nor are they intended to be used to limit the scope of thereof. Other features, aspects, and elements will be readily apparent to a person skilled in the art in view of this disclosure. For example, it should be appreciated that further aspects may be provided by the combination of any two or more of the various aspects described herein.

In a first aspect there is provided a method comprising, at a user equipment, receiving a request for data relating to the user equipment from a further user equipment, wherein the request comprises a reason for the request, generating tagging information, wherein the tagging information includes an indication of the data, an identifier of the user equipment and an identifier of the further user equipment and providing the generated tagging information to the further user equipment, wherein the generated tagging information is integrity protected.

The method may comprise storing the generated tagging information.

The method may comprise providing the generated tagging information to a central auditing function for storage via non-access stratum signalling or via user plane signalling.

The data relating to the user equipment may comprises at least one of location information, identification information or power information.

The generated tagging information may include a time stamp.

The reason for the request may include at least one of: analytics, policy making or network optimisation.

The generated tagging information may be signed using a private key of the user equipment.

The indication of the data may comprise a hash of the data.

The generated tagging information may include an indication of the category of the data.

In a second aspect there is provided a method comprising, at a user equipment, providing a request for data relating to a further user equipment to the further user equipment, wherein the request comprises a reason for the request and receiving tagging information from the further user equipment, wherein the tagging information is integrity protected and includes an indication of the data, an identifier of the user equipment and an identifier of the further user equipment.

In a third aspect there is provided a user equipment comprising means for performing the method according to the first or second aspect.

In a fourth aspect there is provided a user equipment comprising at least one processor, and at least one memory storing instructions which, when executed by the at least one processor, cause the user equipment at least to perform a method according to the first or second aspect.

In a fifth aspect there is provided a non-transitory computer readable medium comprising instructions wherein the instructions when executed by at least one processor of a user equipment cause the user equipment to perform the method according to the first or second aspect.

In a sixth aspect there is provided a computer program comprising instructions which, when executed by a user equipment, cause the user equipment to perform at least the method according to the first or second aspect.

Some embodiments of the invention are defined in the dependent claims.

In the above, many different aspects have been described. As previously noted, it should be appreciated that further aspects may be provided by the combination of any two or more of the aspects described above (or otherwise in this disclosure).

Various other aspects are also described in the following detailed description and in the claims.

### BRIEF DESCRIPTION OF THE FIGURES

Some embodiments will be described, by way of non-limiting and illustrative example only, with reference to the figures, in which:

FIG. 1 shows an example of a communication network to which examples disclosed herein may be applied;

FIG. 2 shows a flowchart of a method according to an example;

FIG. 3 shows a flowchart of a method according to an example;

FIG. 4 shows an example signalling flow between NF1, NF2, NF3 and CAF;

FIG. 5 shows a flowchart of a method according to an example;

FIG. 6 shows a flowchart of a method according to an example;

FIG. 7 shows an example signalling flow between UE1, UE2, AMF/MM NF, UPF and CAF;

FIG. 8 shows an example of an apparatus.

### DETAILED DESCRIPTION

The following embodiments are provided by way of non-limiting and illustrative example. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it intended such feature, structure, or characteristic may be applied in connection with other embodiments (whether or not explicitly described).

It shall be understood that although the terms “first,” “second” and the like may be used herein to describe various elements, these elements should not be limited by these terms. These terms are only used to distinguish one element from another.

For the purposes of this disclosure, the phrases “at least one of A or B”, “at least one of A and B”, and “A and/or B” means (A), (B), or (A and B). For the purposes of this disclosure, the phrase “A, B, and/or C” means (A), (B), (C), (A and B), (A and C), (B and C), or (A, B, and C).

As used herein, the term “or” refers to a non-exclusive “or” unless otherwise indicated (e.g., use of “or else” or “or in the alternative”).

As used herein, unless stated explicitly, performing a respective feature, step, or functionality “in response to A” does not indicate that the respective feature, step, or functionality is performed immediately after “A” occurs as one or more intervening features, steps, or functionalities may be performed (at least in part) between an occurrence of the respective feature, step, or function and “A”. Analogously, performing a respective feature, step, or functionality “based on A” does not indicate that the respective feature, step, or functionality is performed solely based on “A” as the respective feature, step, or functionality may be further based on one or more other features, steps, or functionalities in addition to “A”.

Embodiments described herein may be implemented in a communication network, such as any of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communication network via which user equipment may access the network and/or which is configured to control radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device, such as a satellite network device, a low earth orbit (LEO) satellite and a geosynchronous earth orbit (GEO) satellite, or an aircraft network device.

Moreover, in connection of split radio access network (RAN), the network device may refer to a centralised unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g. server, host or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be configured to perform wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VoIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources may include, e.g., a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources.

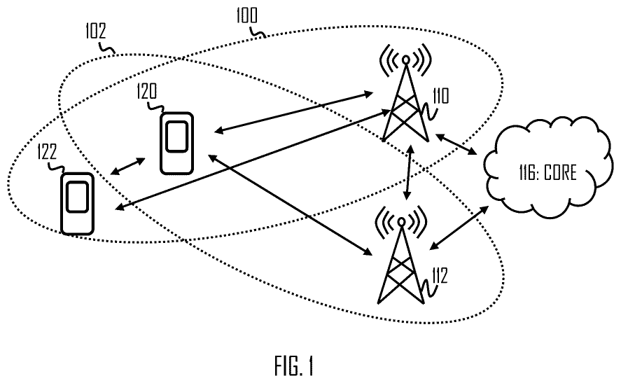

FIG. 1 illustrates an example of a communication network to which examples disclosed herein may be applied. The communication network or a cellular communication network may comprise a network node 110 configured to provide one or more cells, such as cell 100, and a network node 112 configured to provide one or more other cells, such as cell 102. Each cell may, for example, be a macro cell, a micro cell, femto, or a pico cell. The cell may define a coverage area or a service area of the corresponding access node.

The network node (110, 112) may be configured to provide a user equipment (UE) 120 (one or more UEs) with wireless access to the communication network. The wireless access may comprise downlink (DL) communication from the network node (110, 112) to the UE 120 and uplink (UL) communication from the UE 120 to the network node (110, 112). Examples of uplink channels may comprise physical uplink control channel (PUCCH) for transmitting control information and physical uplink shared channel (PUSCH) for transmitting data towards the network. Examples of downlink channels may comprise physical downlink control channel (PDCCH) for transmitting control information and physical downlink shared channel (PDSCH) for transmitting data towards the user equipment.

There may be a plurality of UEs (120, 122) in the system. Each of the plurality of UEs may be served by the same or by different network nodes (110, 112). UE may be configured with dual connectivity (DC), wherein the UE, for example UE 120, may be connected to multiple network nodes (110, 112). The UEs (120, 122) may communicate with each other, in case device-to-device (D2D) communication interface is established between them via a so-called sidelink (SL). Such D2D communications may be referred to as machine-to-machine, peer-to-peer (P2P) communications, or vehicle-to-vehicle (V2V), for example.

In the case of multiple network nodes in the communication network, the network nodes may be connected to each other via an interface. LTE specifications, for example, refer to such an interface as an X2 interface. An interface between an LTE node and a 5G node, or between two 5G nodes may be called an Xn interface.

The network nodes 110 and 112 may be further connected via another interface to a core network 116 of the communication network. The LTE specifications specify the core network as an evolved packet core (EPC), and the core network may comprise a plurality of entities (e.g. a mobility management entity (MME) and a gateway node). The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC). The 5GC may, for example, comprise an access and mobility management function (AMF) and a user plane function/gateway (UPF) and other functions. The AMF may handle termination of non-access stratum (NAS) signalling, NAS ciphering & integrity protection, registration management, connection management, mobility management, access authentication and authorization, security context management. The UPF node may, for example, support packet routing and forwarding, packet inspection and quality of service (QoS) handling.

User data (also referred to as UE data) is used in different RAN nodes, Core NFs and AF. Once a User or UE provides the data to the operator, it is an operator's responsibility to manage the data and take responsibility of the data.

For example, if a UE provides location data to a RAN, the RAN may provide it to LMF NF. LMF may provide the data to NWDAF or other NFs for different use cases. These NWDAF/NFs may further provide the data to other NWDAF/PCF for different use cases.

In another example use case, UE provides AIML related local inference data to RAN and RAN provides it to NWDAF NF. NWDAF may provide it to another NWDAF or other NFs for different use cases. These NWDAF/NFs may further provide it to other PCF/AMF/MM NF for different use cases

User data flow in the operator network should be tracked for auditing purpose. It is important for data life cycle management. For example, an operator may be liable to hold user data for 3 years and so whichever NF/service is consuming the user data, should be tracked for these years. There is currently no way to track data and its life cycle over a period of time in the 3GPP network. A similar problem may arise for UE-to-UE data sharing as well. When a first UE, UE1, shares data with a second UE, UE2, e.g., via a 3GPP defined interface (PC5), it is a responsibility of the operator track the data.

Data tracking may include lineage tracking, e.g., tracing data life cycle to ensure privacy, security and compliance.

Alternatively, or in addition, data tracking may include real time data usage monitoring. Proactivity may detect unauthorized access and ensure secured exposure.

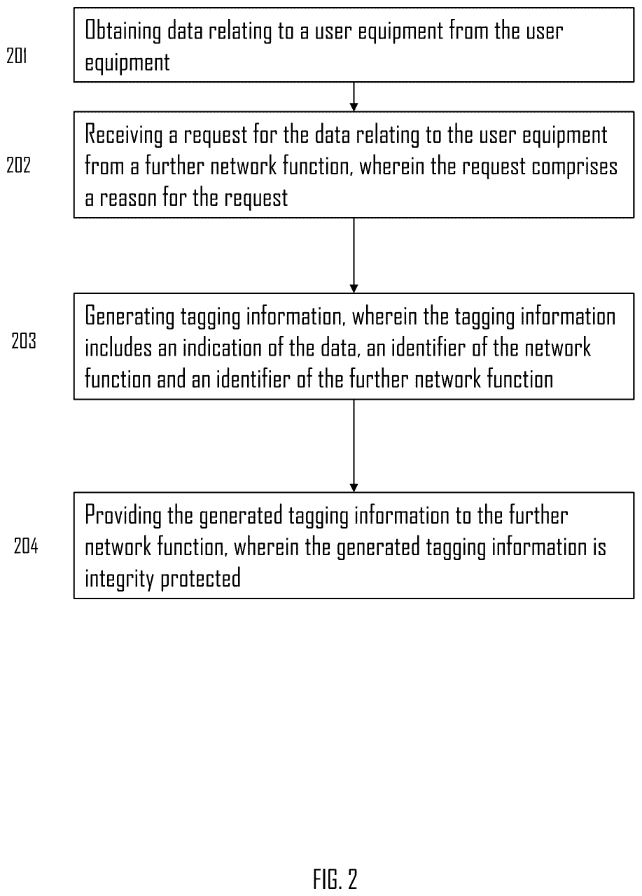

FIG. 2 shows a flowchart of a method according to an example embodiment. The method may be performed at an apparatus. The apparatus may comprise, be, or be comprised in a network function. The network function may be referred to as a NF producer or NFp. As an example, the NF may be a LMF or NWDAF.

At 201, the method comprises obtaining data relating to a user equipment from the user equipment.

At 202, the method comprises receiving a request for the data relating to the user equipment from a further network function, wherein the request comprises a reason for the request.

At 203, the method comprises generating tagging information, wherein the tagging information includes an indication of the data, an identifier of the network function and an identifier of the further network function.

At 203, the method comprises providing the generated tagging information to the further network function, wherein the generated tagging information is integrity protected.

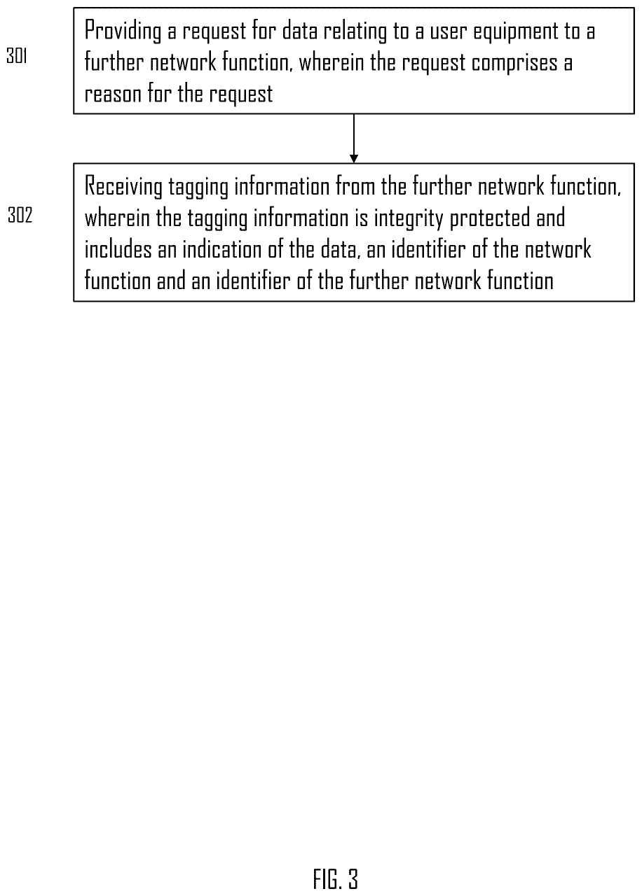

FIG. 3 shows a flowchart of a method according to an example embodiment. The method may be performed at an apparatus. The apparatus may comprise, be, or be comprised in a network function. The network function may be referred to as a NF consumer or NFc.

At 301, the method comprises providing a request for data relating to a user equipment to a further network function, wherein the request comprises a reason for the request.

At 302, the method comprises receiving tagging information from the further network function, wherein the tagging information is integrity protected and includes an indication of the data, an identifier of the network function and an identifier of the further network function.

In a method as described with reference to FIGS. 2 and 3, each NF producer (including, e.g., the RAN SBA NF) that provides data also tags the data and sign it, i.e. by providing integrity protected tagging information to the NF consumer. This ensures that NF producer is taking a responsibility of data generated by NF producer. The NF producer may also stores the data and tagging information on a central auditing function. Data relating to the user equipment may be any user data and may comprise, for example, at least one of location information, identification information or power information.

The methods as described with reference to FIGS. 2 and 3 may comprise storing the generated or received tagging information, respectively.

The generated or received tagging information may be stored at a central auditing function (CAF). CAF is a new network function in the 6G that can store the data and tagging information. CAF may be realized in the core network and/or RAN domain.

Tagging information may be stored in a new CAF NF (e.g., external to the NF producer or consumer) or CAF service locally (e.g. internal to the NF producer or consumer). For the local option, CAF is a functionality or service provided by each NF. Each NF may support CAF service and stores the tagging information. The network function may provide the generated or received tagging information to the central auditing function.

The tagging information may be used for auditing purpose. CAF NF or functionality provides a way where user data can be tracked. For example, who generates user data, who consume user data and what is the reason for consuming or sharing the user data may be able to be tracked.

Tagging information that includes user data is defined. The tagging information is integrity protected. The generated tagging information may be integrity protected based on a signature signed using a private key of the apparatus. The information is signed by NF itself so that the information can not be modified (i.e. the information is integrity protected). Alternatively, or in addition different cryptographic function may be used to ensure tagging integrity.

The reason for the request may include at least one of: analytics, policy making or network optimisation. This requesting Reason IE can be introduced in each service request or can be a part of custom header. E.g. Requesting Reason=analytics, self-consume for policy making, self-consume for network optimization etc.

The tagging information may include a time stamp. The tagging information includes an indication of the category of the data.

For example, tagging information may include {Information IE: UE data related IE, Producer ID, Consumer ID, Requesting Reason: analytics, self-consume for policy making, self-consume for network optimization, Time stamp: actual time of tagging}

The method as described with reference to FIG. 2 may comprise providing the generated tagging information to the further network function via a service application programming interface (API) or a header. For example, tagging information may be provided from Producer to consumer as a part of service API or via a custom header.

A new custom header may be introduced. This custom header may be named as 3gpp-SBI-tagingInfo {
Information IE: It contains UE data related IE.
Producer ID
Consumer ID
Requesting Reason: analytics, self-consume for policy making, self-consume for network optimization
Time stamp: actual time of tagging,
Signature: signature of NF1 or the data producer generating/aggregating/collecting the data for providing to the data consumer
}

This custom header may be attached to any service request. NF producers may provide this information to NF consumer along with data.

Some optimizations can be performed here to avoid duplicate data. For example. the indication of the data may comprise a hash of the data as follows.
3gpp-SBI-tagingInfo {
Hash of data: Instead of actual data, hash of data is kept. Actual data is transferred in the API/service request
Producer ID
Consumer ID
Requesting Reason: analytics, self-consume for policy making, self-consume for network optimization
Time stamp: actual time of tagging,
Signature: signature of the data producer generating/aggregating/collecting the data for providing to the data consumer

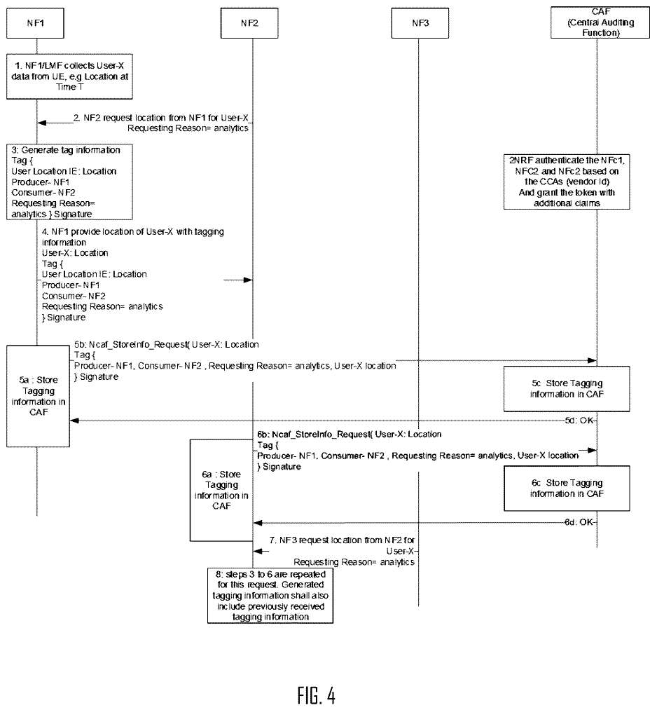

FIG. 4 shows a signaling flow between NF1, NF2, NF3 and CAF according to an example.

NF1 is a producer which obtains data relating to a user equipment either by collecting user data directly from a UE or via other means or generates UE related data. For example. location is determined by LMF, NWDAF determines the UE historical communication patterns.

At step 1, NF1, collects User data from a UE, e.g., location at time T.

At step 2, NF2 request the data relating to the UE from NF1. NF2 includes a requesting Reason IE. In this example, the requesting reason is analytics.

At step 3, which may take place after authorization and authentication, NF1 determines to provide the requested data to NF2. For this, NF1 determines the tagging information. Let's assume the UE related data is a UE location, then the tagging information contains
{User Location IE: actual UE location,
Producer: NF1
Consumer: NF2
Requesting Reason: analytics,
Time stamp: actual time of tagging }, {Signature of NF1 (i.e. data producer)}

This tagging data is signed by NF1 by its private key.

At step 4, the tagging information is provided from NF1 to NF2. The tagging information may be provided to NF2 (e.g., consumer NF or NFc) via a custom header.

At step 5, the tagging information is stored in the CAF.

At step 5a, the tagging information is stored at a CAF functionality at the NF.

At step 5b, NF producer invokes the Ncaf_StoreInfo_Request API of the CAF NF and request to store the tagging information defined in step 3. CAF NF stores the information.

At step 6, step 5 can also be repeated by NF consumer once it receives service response from the NF producer with tagging information. i.e. NF consumer can also store the information at the CAF NF.

At steps 7 and 8, NF3 requests data from NF2 and step 3 to 6 are repeated with NF2 as the NF producer and NF3 as the NF consumer. Tagging information generated by NF2 can be stored at CAF NF or NF functionality at NF2 or NF3. Where NF2 generates further tagging information, the further tagging information may comprise the received tagging information.

For example, if NF2 consumer receives the information from another NF (NF1), then NF2 may also include tagging information received previously. E.g.
3gpp-SBI-tagingInfo {
Information IE: It contains UE data related IE.
Producer ID
Consumer ID
Requesting Reason: analytics, self-consume for policy making, self-consume for network optimization Time stamp: actual time of tagging
Previously Received tag list: Tag1 . . .
}

Data tracking can be ensured by appending the signed data tags (i.e. integrity protected tagging information) as the data is being distributed around, such that any data consumer/operator can at any given time track all the data consumers which accessed the data and for what purposes. Alternatively, or in addition, a centralized variant of CAF may ensure that all the data producers/consumers are updating the tagging info in a central NF, thereby optimizing the control and audit operations

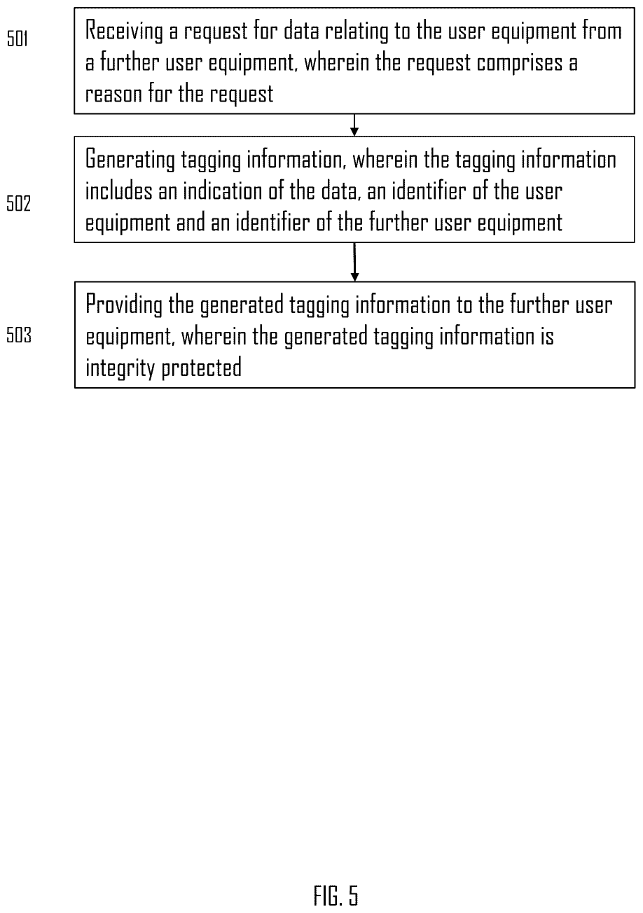

FIG. 5 shows a flowchart of a method according to an example embodiment. The method may be performed at an apparatus. The apparatus may comprise, be, or be comprised in a user equipment. The user equipment may be referred to as a UE producer.

At 501, the method comprises receiving a request for data relating to the user equipment from a further user equipment, wherein the request comprises a reason for the request.

At 502, the method comprises generating tagging information, wherein the tagging information includes an indication of the data, an identifier of the user equipment and an identifier of the further user equipment.

At 503, the method comprises providing the generated tagging information to the further user equipment, wherein the generated tagging information is integrity protected.

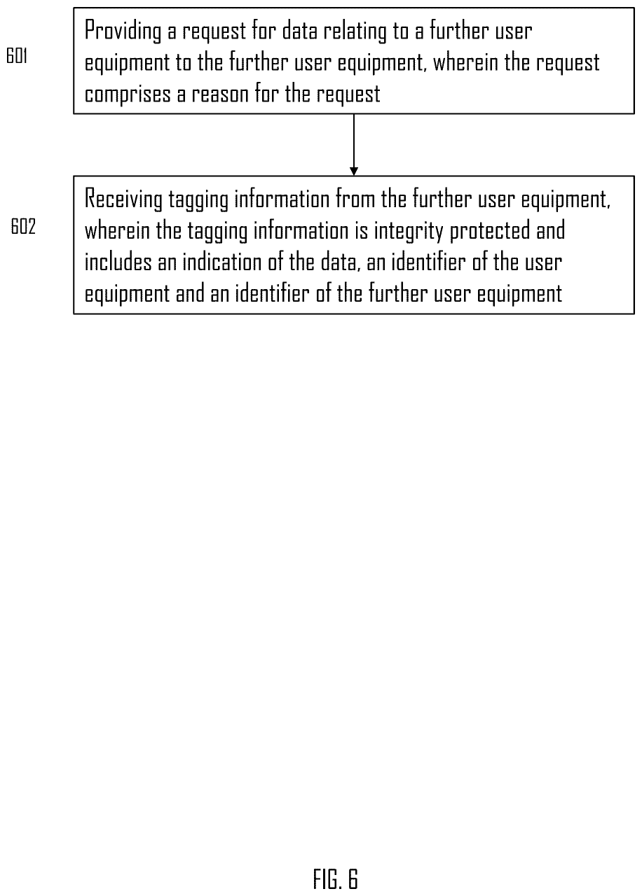

FIG. 6 shows a flowchart of a method according to an example embodiment. The method may be performed at an apparatus. The apparatus may comprise, be, or be comprised in a user equipment. The user equipment may be referred to as a UE consumer.

At 601, the method comprises providing a request for data relating to a further user equipment to the further user equipment, wherein the request comprises a reason for the request.

At 602, the method comprises receiving tagging information from the further user equipment, wherein the tagging information is integrity protected and includes an indication of the data, an identifier of the user equipment and an identifier of the further user equipment.

The user equipment may be caused to perform storing the generated tagging information. The user equipment may be caused to provide the generated tagging information to a central auditing function for storage via non-access stratum signalling or via user plane signalling. In an example, the UE pushes the Tagging information to the network (or new CAF NF). The tagging information may then be used for user data auditing purposes.

Tagging information is integrity protected, for example signed by a private key of the UE. (Assuming UE is configured with certificates).

The reason for the request may include at least one of: analytics, policy making or network optimisation. This requesting Reason IE can be introduced in each service request or can be a part of custom header. E.g. Requesting Reason=analytics, self-consume for policy making, self-consume for network optimization etc. The tagging information may include a time stamp. The tagging information may include an indication of the category of the data. The data relating to the user equipment may comprise at least one of location information, identification information or power information.

For example, tagging information may include {Information IE: It contains UE data related IE, Producer UE ID, Consumer UE ID, Requesting Reason: analytics|self-consume for policy making, Time stamp: actual time of tagging. This information is signed by UE itself so that it cannot be modified (integrity protected)

Tagging information may be provided from Producer UE to consumer UE as a part of service API or via a custom header in PC5.

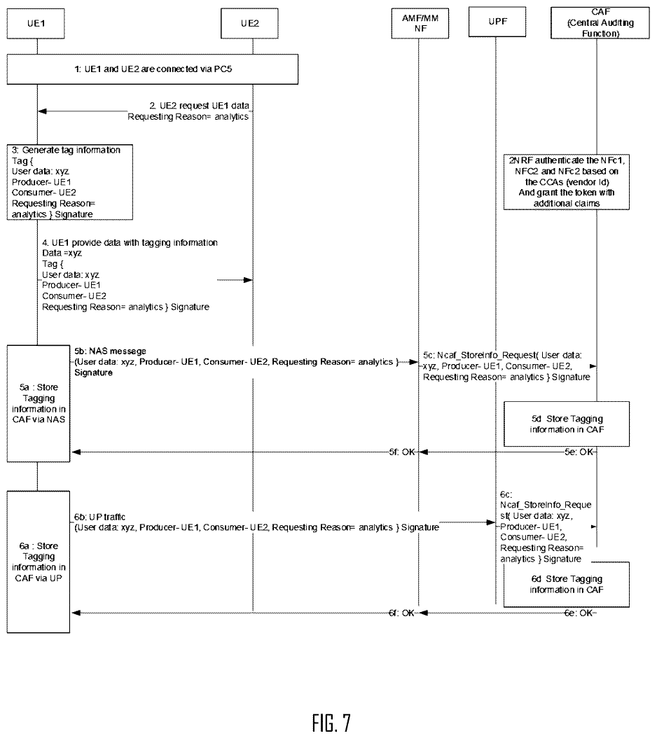

FIG. 7 shows an example signalling flow between a first UE, UE1, second UE, UE2 and NFs including AMF/MM, UPF and CAF. The steps are similar to those shown in FIG. 4.

At step 1, UE1 and UE2 are connected via PC5.

At step 2, UE2 requests data from UE1

At steps 3 and 4, UE generates the tagging information. UE uses its certificate and pub/private key to generate the tag.

At step 5, in a NAS based solution, the UE provides tagging information to the network via NAS message or payload. Then AMF/MM NF stores the same in CAF NF via SBA.

At step 6, in a UP based solution, the UE provides tagging information to the network via User plane. For this, UE creates a PDU session and upload data to UPF. Then UPF stores the same in CAF NF via SBA.

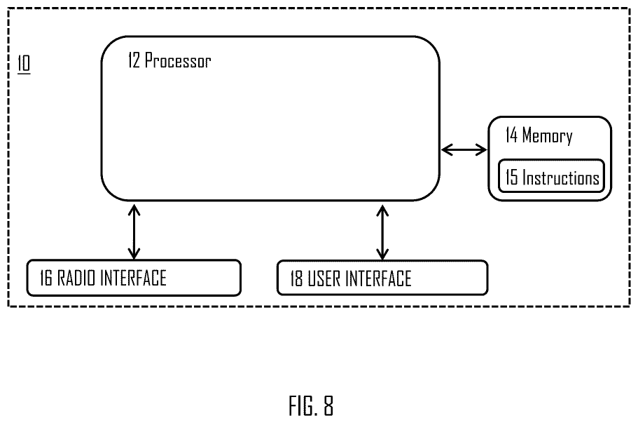

FIG. 8 shows, by way of example, a block diagram of an apparatus 10. The apparatus 10 comprises, for example, at least one processor 12 and at least one memory 14 storing instructions 15 that, when executed by the at least one processor, cause the apparatus 10 at least to perform the method or methods (or portion(s) thereof) as disclosed herein, and any of the embodiments (or respective portion(s) thereof). In an example, the at least one memory and the instructions (e.g. a computer program code, software), are configured, with the at least one processor, to cause the apparatus 10 to perform the method or methods (or portion(s) thereof) as disclosed herein, and any of the embodiments (or respective portion(s) thereof).

A processor 12 may comprise circuitry, or be constituted as circuitry or circuitries, the circuitry or circuitries being configured to perform phases of methods in accordance with embodiments described herein.

As used herein, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may, for example, be at least in part external to apparatus 10 but accessible to apparatus 10.

The instructions 15 may be comprised in a computer readable medium or a non-transitory computer readable medium. A term non-transitory, as used herein, is a limitation of the medium itself (i.e. tangible, not a signal) as opposed to a limitation on data storage persistency (e.g. random access memory, RAM, vs. read only memory, ROM).

For example, the apparatus 10 is a terminal device, such as a UE. As another example, the apparatus is comprised in such a terminal device, e.g. as a chipset configured to control the terminal device. The apparatus 10 may be caused or configured or comprise means to perform at least the method of FIGS. 5 and/or 6 and/or any one or more of the embodiments described herein.

As another example, the apparatus 10 is a network entity. In another embodiment, the apparatus is comprised in such a network entity, e.g. as a chipset configured to control the network entity. The apparatus 10 may be caused or configured or comprise means to perform at least the method of FIGS. 2 and/or 3 and/or any one or more of the embodiments described herein.

The apparatus may comprise one or more entities of any of protocol layers, such as a MAC entity, an RRC entity, an RLC entity, a PDCP entity or a PHY entity. In some embodiments, the entity is configured to perform at least the method of FIGS. 3, 4 and/or 8, and/or any one or more of the embodiments described.

The apparatus 10 comprises a radio interface 16. The radio interface 16 may provide the apparatus 10 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 10 may comprise a user interface 18 comprising, for example, at least one of a keypad, a microphone, a touch display, a display, a speaker, etc. The user interface 18 may be used to control the apparatus by the user. The user interface 18 may be external to the apparatus 10. For example, the apparatus 10 may be connected to another device, such as a computer, either via wireless or wired connection, and the apparatus 10 is controlled by the user via the computer.

In an embodiment, at least some of the processes described herein may be carried out by an apparatus comprising means for carrying out at least some of the described processes. Means for performing method steps as disclosed herein may include software and/or hardware components of the apparatus 10. For example, the at least one processor 12, the memory 14, and the computer program code form means for carrying out the method or methods (or portion(s) thereof) as disclosed herein, and any of the embodiments (or respective portion(s) thereof). As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though this disclosure has been described above with reference to non-limiting and illustrative examples according to the accompanying figures, it is clear that the scope of this disclosure is not restricted thereto—but can be modified in many different ways. As technology advances, it will become apparent to a person skilled in art as to how the disclosure can be further implemented and/or modified in various ways. Further, it is clear to a person skilled in the art that the embodiments described herein may, but are not required to, be combined in various ways with other embodiments described herein.

We claim:

1. A user equipment comprising: at least one processor and at least one memory storing instructions that, when executed by the at least one processor, cause the user equipment at least to perform:
receiving a request for data relating to the user equipment from a further user equipment, wherein the request comprises a reason for the request;
generating tagging information, wherein the tagging information includes an indication of the data, an identifier of the user equipment and an identifier of the further user equipment; and
providing the generated tagging information to the further user equipment, wherein the generated tagging information is integrity protected.

2. The user equipment according to claim 1, wherein the user equipment is caused to perform storing the generated tagging information.

3. The user equipment according to claim 2, wherein the user equipment is caused to provide the generated tagging information to a central auditing function for storage via non-access stratum signalling or via user plane signalling.

4. The user equipment according to claim 1, wherein the data relating to the user equipment comprises at least one of location information, identification information or power information.

5. The user equipment according to claim 1, wherein the generated tagging information includes a time stamp.

6. The user equipment according to claim 1, wherein the reason for the request includes at least one of: analytics, policy making or network optimisation.

7. The user equipment according to claim 1, wherein the generated tagging information is signed using a private key of the user equipment.

8. The user equipment according to claim 1, wherein the indication of the data comprises a hash of the data.

9. The user equipment according to claim 1, wherein the generated tagging information includes an indication of the category of the data.

10. A user equipment comprising: at least one processor and at least one memory storing instructions that, when executed by the at least one processor, cause the apparatus at least to perform:
providing a request for data relating to a further user equipment to the further user equipment, wherein the request comprises a reason for the request; and
receiving tagging information from the further user equipment, wherein the tagging information is integrity protected and includes an indication of the data, an identifier of the user equipment and an identifier of the further user equipment.

11. A method comprising, at a user equipment:
receiving a request for data relating to the user equipment from a further user equipment, wherein the request comprises a reason for the request;
generating tagging information, wherein the tagging information includes an indication of the data, an identifier of the user equipment and an identifier of the further user equipment; and
providing the generated tagging information to the further user equipment, wherein the generated tagging information is integrity protected.
